(19) United States
(12) Patent Application Publication
(10) Pub. No.: US 2008/0091733 A1
(43) Pub. Date: Apr. 17, 2008

(54) REUSABLE DATA QUERY LANGUAGE STATEMENTS

(76) Inventors: Scott Shelton, Apex, NC (US); David Carmer, Cary, NC (US); Henry Fu, Chapel Hill, NC (US); Jason Figge, Cary, NC (US); Leslie Mannion, Wake Forest, NC (US); Christian Seifert, Durham, NC (US); Anish Shah, Apex, NC (US); Linette Draper, Escondido, CA (US); Robert Baril, Apex, NC (US)

Correspondence Address: James M. Stover;Intellectual Property Section, Law Department, NCR Corporation, 1700 South Patterson Blvd., Dayton, OH, 45479-0001, US

(21) Appl. No.: 11/549,721

(22) Filed: Oct. 16, 2006

(51) Int. Cl. G06F 17/30

(52) U.S. Cl. 707/200

(57) ABSTRACT

Techniques are presented for reusable data query language statements. User-defined parameter variables with parameter types are interspersed in data query language statements to form a rule. The rule may execute as a standalone application or as part of another application or service. When the rule is executed, parameter values for the parameter variables are dynamically acquired and populated into the data query language statements.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be described below and in the drawings that form a part of this document: Copyright © 2006, NCR Corp. All Rights Reserved.

### FIELD

The invention relates generally to data store processing and more particularly to techniques for reusable data query language statements.

### BACKGROUND

The use of database technology has become critical to enterprises. Most successful enterprises now capture data from a variety of sources and index that data in databases, where the data is subsequently assimilated to drive customer relationships, revenues, and virtually all aspects of the enterprises.

A database is often accessed via an Application Programming Interface (API) associated with the database, such as SQL. One or more SQL statements can be organized as applications that perform a variety of operations against the database, such as generating reports, executing multiple queries, etc.

Usually personnel within the enterprise, which generate SQL or SQL applications, are skilled engineers that interact with business or customer-oriented personnel of the enterprise who have a desire to access and assimilate data in the database. Accordingly, there may have to be some iterative communication that has to occur before business personnel ultimately acquire their desired SQL or SQL applications.

Additionally, the SQL or SQL applications developed are likely just reusable if the same developer is used by business personnel with similar requirements and then only if that engineer recalls what he/she had done before. Even in this case, the engineer likely creates an entirely new instance of the SQL or SQL application that was previously developed for the new request with specific modifications being used in the new request.

It is apparent that this process is fraught with inefficiencies that are not conducive to reuse. Moreover, the process is often heavily dependent on the developers, if reuse is to be successful.

Thus, it can be seen that improved techniques for reuse, when accessing databases, are desirable.

### SUMMARY

In various embodiments, techniques for providing reusable data query language statements. In an embodiment, a method is provided that receives a parameter type and a parameter variable for a data query language statement. The processing associated with receiving is iterated zero or more additional times for additional parameter types and additional parameter variables for the data query language statement or for additional data query language statements. Also, a rule is created that represents the parameter type, the parameter variable, the data query language statement, and any additional parameter types, any additional parameter variables, and any additional data query language statements.

### BRIEF DESCRIPTION OF THE DRAWINGS

FIG. 1 is a diagram of a method for generating a rule for reusable data query language statements, according to an example embodiment.

FIG. 2 is a diagram of a method for providing a graphical user interface (GUI) tool that generates and uses reusable SQL statements as a rule, according to an example embodiment.

FIG. 3 is a diagram of a reusable SQL statement system, according to an example embodiment.

FIG. 4 is a screenshot of an example GUI tool, according to an example embodiment.

FIG. 5 is another screenshot of an example GUI tool, according to an example embodiment.

### DETAILED DESCRIPTION

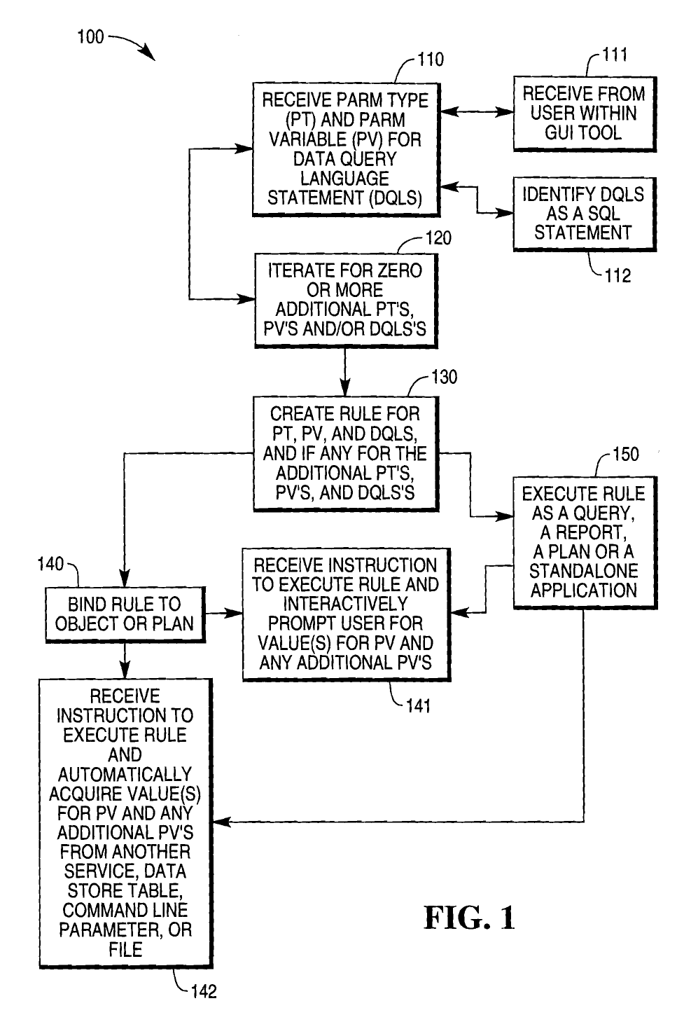

FIG. 1 is a diagram of a method 100 for generating a rule for reusable data query language statements, according to an example embodiment. The method 100 (hereinafter “data query language service”) is implemented in a machine-accessible or computer-readable medium as instructions that when executed by a machine (processing device) performs the processing depicted in FIG. 1. Moreover, the data query language service is accessible over a network. The network may be wired, wireless, or a combination of wired and wireless.

A “data store” as used herein may include a database, a collection of databases organized as a data warehouse, a directory, a collection of directories cooperating with one another, or various combinations of the same. According to an embodiment, the data store is a Teradata® warehouse product or service distributed by NCR Corporation of Dayton, Ohio.

A “data query language” refers to an Application Programming Interface (API) used to access and perform operations on the data store. In an embodiment, the data query language is SQL. Although it is noted that any commercial data query language API or proprietary data query language API may use and benefit from the teachings presented herein with respect to the data query language service.

Within this context, the processing of the data query language service is now discussed with reference to the FIG. 1. At 110, the data query language service receives a parameter type and a parameter variable name (herein after referred to as “parameter variable”) for a data query language statement. According to an embodiment, at 111, the parameter type and parameter variable are received via a GUI tool that a user interacts with. Furthermore and in an embodiment, at 112, the data query language statement may be identified as SQL.

According to an embodiment, the parameter variable may be readily identified in the data query language statement using a special character, such as but not limited to “@.” Additionally, a string of characters may be used, such as but not limited to “##.” For example, a modified SQL statement may appear as “SELECT @NAME FROM X.” The “@NAME” permits the variable parameter variable of “NAME” to be parsed and recognized within the SQL statement and replaced with a specific value at runtime.

The parameter variable is not case sensitive, such that “NAME” is indistinguishable from “name.” Although, if desired, the parameter variable may be case sensitive, such that “NAME” and “name” are not considered the same parameter variable. The parameter variable may also be selectable from predefined and available lists of parameter variables. Alternatively, the user may custom-define a particular parameter variable.

The parameter types for the parameter variables can include a variety of data types, such as standard data types available within the data query language itself, such as SQL data types. Additionally, some data types may be user defined or custom defined. The parameter types are selectable by a user and are associated with the parameter variables. That is, each parameter variable includes a corresponding parameter type. The type permits the data query language service and any subsequent execution service to enforce data typing on values that are subsequently supplied for parameter variables. So, a parameter type of Boolean for a parameter variable of “Yes_or_No” does not support a subsequent attempt to supply a value of “1000,” which is an integer.

Some example parameter types include:
Boolean—selection between two choices;
Database Table Name—selection of a database table name;
Date—selection of fixed data formats (e.g., Dec. 25, 2006, Dec. 25, 2006, etc.) or floating dates (e.g., two weeks from today or prior to today or some fixed date);
Decimal—a floating point number;
Group By—selection of predefined columns, which are appended sequentially in the “GROUP BY” clause of a SQL query;
Integer—a whole number;
List—selection of a value from a list, which can contain predefined options or linked to a database table/field;
Object ID—selection of one or multiple objects of a specified type (e.g., in SQL, the parameter is replaced with a comma-separated list of Object ID's and a select ID used in an “IN” clause of a SQL query);
Segment—creation of new or existing segment from segmentation and replaced by a “SELECT” query generated for the segment; and
Text—any character or string value for a SQL parameter.

By separating the parameter types from the actual parameter values of the parameter variables, reuse and flexibility is increased. A user can focus on their individual goals using their individual values. Typically, one person creates SQL and parameter type definitions while another person actually uses the SQL. So, using a goal-oriented architecture, the user-interface is streamlined, such that single or multiple users for creation and use of the SQL can occur.

At 120, the data query language service iterates the processing of 110 zero or more additional times for purposes of acquiring additional parameter types for additional parameter variables and perhaps additional data query language statements. So, a user may have multiple data query language statements having multiple parameter variables embedded therein. It is noted that any given parameter variable may be reused and shared within the context of all the data query language statements. So, if a user defined a parameter variable of “NAME” in one SQL statement; the same parameter variable may be referenced and used in additional SQL statements.

At 130, the parameter variable, its parameter type, and the data query language statement are used to create a rule or application object. If there were any additional parameter variables, additional parameter types, and additional data query language statements, then these are also included within the definition and creation of the rule.

Essentially, the rule is a collection of data query language statements having shared parameter variables and types (parameter definitions). In some cases, this collection is for SQL statements having the shared parameter definitions. These statements may be subsequently executed in specified order or executed conditionally based on the success or failure of certain queries.

In an embodiment, a single rule is represented using one or more SQL statements and parameter definitions are stored as local referenced objects. In cases, where a rule includes multiple data query language statements the order of execution is specified, such as through conditional branching based on success or failure of execution of a particular data query language statement (e.g., if SQL_Statement_{—}1 succeeds run SQL_Statement_{—}2; if SQL_Statement_{—}1 fails, run SQL_Statement_{—}3, etc.).

The data query language statements may include any operation supported by the API of the data query language being used. Also, parameter variables are shared amongst each of the data query language statements in the rule.

According to an embodiment, at 140, the rule may be bound to an object or plan. That is, the rule may be referenced or incorporated within another application or service, such as a report, etc.

In some cases, at 141, the data query language service may receive an instruction to execute the object, plan, application, or service that the rule is bound to, referenced in, or embedded in. At this point values for the parameter variable and any additional parameter variables are acquired by interactively prompting a user to supply the value or values at runtime or execution time.

In other cases, at 142, the data query language service may dynamically acquire the value or values for the parameter variable and any additional parameter variables from another service, application, data store table, file, or even from command line parameters supplied when executing the object, plan, application, or service to which the rule is bound to, referenced in, or embedded in.

It may also be the case, at 150 that the rule itself is an application, such that it is an independent or standalone executable entity that does not rely on another object, plan, application, or service to execute. So, at 150, the rule may be executed upon instruction to do so. Similarly, the parameter values for the parameter variables may be obtained in manners depicted in 141 and 142 and discussed above.

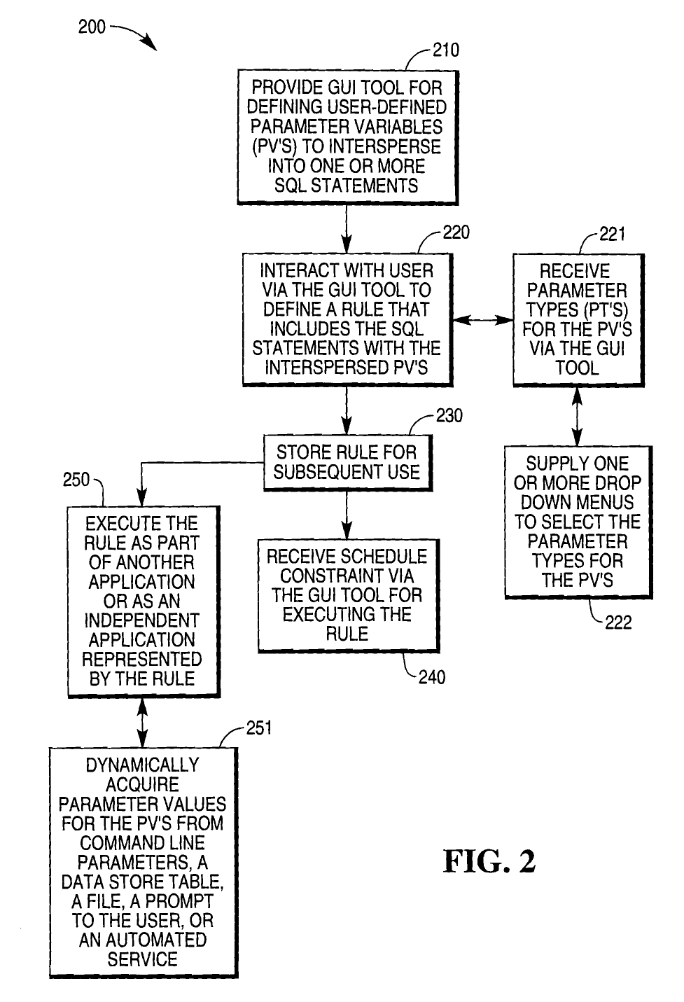

FIG. 2 is a diagram of a method 200 for providing a graphical user interface (GUI) tool that generates and uses reusable SQL statements as a rule, according to an example embodiment. The method 200 (hereinafter “GUI tool”) is implemented in a machine-accessible and readable medium as instructions that when executed by a machine performs the processing reflected in FIG. 2. The GUI tool may also be accessible over a network. The network may be wired, wireless, or a combination of wired and wireless.

The GUI tool compliments and may utilize the data query language service represented by the method 100 of the FIG. 1. That is, the GUI tool on the front end interacts with a user and on the back end may interact with the data query language service.

At 210, the GUI tool is provided to a user for interaction and for defining user-defined parameter variables, which are to be interspersed into one or more SQL statements. These modified SQL statements will acquire parameter values for the defined parameter variables when the executed as a rule object. The rule may be a standalone application or embedded, bound, or referenced within another application or service.

At 220, the GUI tool is used to interact with a user for purposes of defining the rule, which includes the interspersed parameter variables within the one or more SQL statements as modified SQL statements.

According to an embodiment, at 221, the GUI tool may also be used to receive from the user parameter types of the parameter variables. At 222, the parameter types may be supplied to the user via the GUI tool as one or more drop down menus for user selection. That is, a list of predefined parameter types may be supplied in a drop down menu within the GUI for the user to select.

At 230, the rule is stored for subsequent use. In some cases, at 240, the GUI tool may also be used to identify scheduling constraints with the rule. A scheduling constraint may be used to identify when and how frequently a rule is to be subsequently executed.

In an embodiment, at 250, the rule may be subsequently executed as part of another application or executed as its own standalone application. Additionally, at 251 and at runtime, parameter values for the parameter variables may be dynamically acquired and resolved from a variety of mechanisms. For instance, the runtime user may be dynamically prompted at runtime of the rule to supply the values for the parameter variables. In other cases, the parameter values may be acquired as runtime or command line parameters, acquired from a data store table, acquired from a file, acquired from another automated application or automated service.

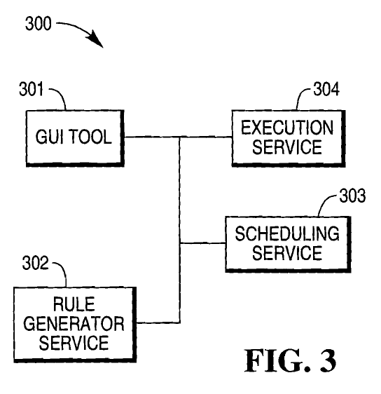

FIG. 3 is a diagram of a reusable SQL statement system 300, according to an example embodiment. The reusable SQL statement system 300 is implemented in a machine-accessible and readable medium and is operational over a network. The network may be wired, wireless, or a combination of wired and wireless. In an embodiment, portions of the reusable SQL statement system 300 implements, among other things the service and tool represented by the methods 100 and 200 of the FIGS. 1 and 2, respectively.

The reusable SQL statement system 300 includes a GUI tool 301 and a rule generator service 302. The reusable SQL statement system 300 may also include a scheduling service 303 and/or an execution service 304. Each of these will now be discussed in turn.

The GUI tool 301 is used to interact with a user that is developing a rule. A rule is a collection of modified SQL statements. The user supplies one or more SQL statements and defines a variety of parameter variables to intersperse within the SQL statements. The parameter variables are also associated with parameter types or data types. The combination of a parameter variable and its parameter type is a parameter definition. A parameter definition is reusable and capable of being referenced and shared throughout the SQL statements; that is, a single parameter definition is not tied to and does not have to be redefined to be used in other SQL statements supplied by the user via interaction with the GUI tool 301.

According to an embodiment, the GUI tool 301 is segmented into a variety of visual frames for user inspection and interaction. For example, one frame may dynamically present the collection of modified SQL statements as a user defines a parameter variable and a particular SQL statement for the rule being constructed.

An example GUI tool 301 was presented and described in detail above with reference to the method 200 of the FIG. 2.

The rule generator service 302 interacts on the backend with the GUI tool 301 for purposes of generating, creating, or assembling a rule. The rule may be bound to, referenced within, or embedded within another application, object, plan, or service. Alternatively, the rule may be a standalone and independently executable application or service. The rule is a collection of the modified SQL statements having the parameter definitions referenced therein. Example processing associated with the rule generator service 302 was presented above with reference to the method 100 of the FIG. 1 and with reference to the method 200 of the FIG. 2.

In some cases, the reusable SQL statement system 300 may also include a scheduling service 303. The scheduling service 303 is for receiving and processing scheduling constraints for the generated rule or for the application or service that uses the generated rule. So, the rule may be executed at specific times, dates, or even intervals.

The reusable SQL statement system 300 may also include an execution service 304. The execution service 304 is for dynamically interpreting or inspecting the rule when it is executed to dynamically acquire parameter values for the interspersed parameter variables. The execution service 304 may also be used to enforce any supplied values to ensure they conform to identified parameter types or the parameter variables.

The execution service 304 is dynamically invoked when the rule is executed or referenced within an executable application or service. At this point, the execution service 304 may acquire the parameter values for the parameter variables in a number of manners, such as via interactive and dynamic prompting of a runtime user, from a file, from a data store table, from command line parameters, and the like.

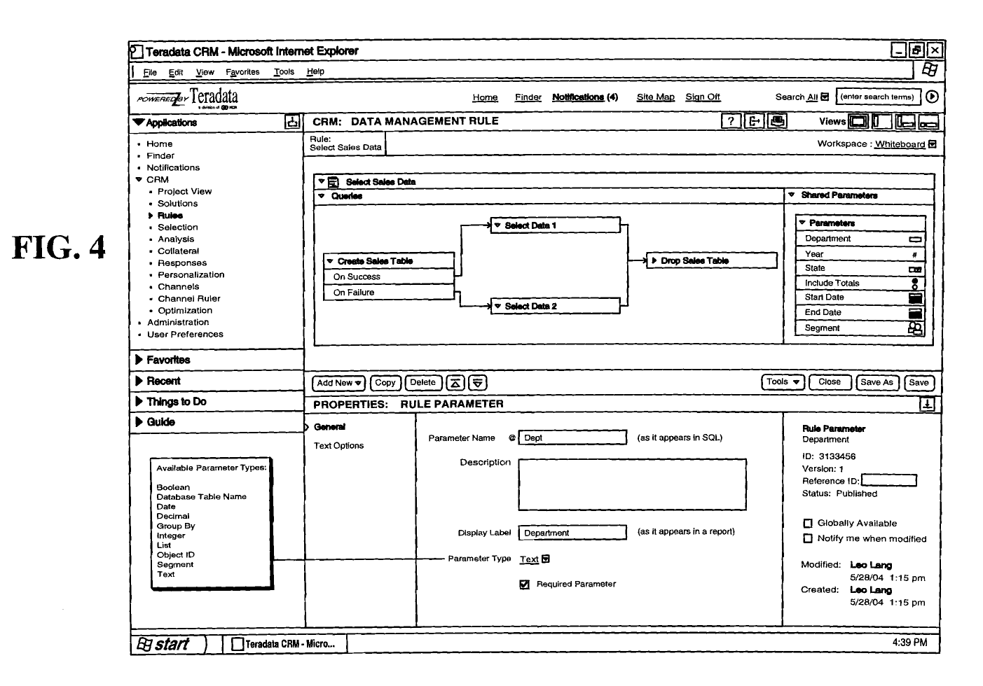

FIG. 4 is a screenshot of an example GUI tool, according to an example embodiment. In FIG. 4, the bottom frame of the GUI tool shows how SQL statements acquire parameter variables, such as “Dept” and how the statements are assigned a parameter type, such as “text.” Other metadata and constraints may be provided for as well, such as versioning information, report labels, and the like. The top leftmost frame shows how existing rules may be called up for use or modification. The top rightmost frame shows graphical relationships in the SQL statement and includes a far right frame that identifies shared parameter variables for use with the SQL statement for this particular rule being defined, modified, or used.

FIG. 5 is another screenshot of an example GUI tool, according to an example embodiment. This example shows how the GUI tool may interrelate and display SQL statements and parameters in a single screenshot. Again, this is presented for purposes of illustration and comprehension only and is not intended to limit embodiments of the invention presented herein and above.

It is to be understood that the screenshot is presented for purposes of comprehension only and as one example. The embodiments of the invention are not tied to any particular presentation within the GUI tool.

The above description is illustrative, and not restrictive. Many other embodiments will be apparent to those of skill in the art upon reviewing the above description. The scope of embodiments should therefore be determined with reference to the claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a parameter type and a parameter variable for a data query language statement;
iterating the processing associated with receiving zero or more additional times for additional parameter types and additional parameter variables for the data query language statement or for additional data query language statements; and
creating a rule that represents the parameter type, the parameter variable, the data query language statement, and any additional parameter types, any additional parameter variables, and any additional data query language statements.

2. The method of claim 1 further comprising, binding the rule to an object or a plan.

3. The method of claim 2 further comprising:
receiving an instruction to execute the object or the plan; and
interactively prompting a user to provide one of more values for the parameter variable and any additional parameter variables, wherein when the parameter variable or any additional parameter variables are referenced multiple times within the rule, the user is prompted once for the appropriate value.

4. The method of claim 2 further comprising:
receiving an instruction to execute the object or the plan; and
automatically acquiring one or more values from the parameter variable and any additional parameter variables from at least one of another service, a data store table, a command line parameter, and a file.

5. The method of claim 1, wherein receiving further includes receiving the parameter type, the parameter variable, and the data query language statement from a user within a graphical user interface (GUI) tool.

6. The method of claim 1 further comprising, identifying the data query language as an SQL language statement.

7. The method of claim 1 further comprising, executing the rule as at least one of a query, a report, a plan, and a standalone application.

8. A method, comprising:
providing a graphical user interface (GUI) tool for defining user-defined parameter variables to intersperse in one or more SQL statements;
interacting with a user via the GUI tool to define a rule that includes the one or more SQL statements with the interspersed user-defined parameter variables; and
storing the rule for subsequent use.

9. The method of claim 8, wherein interacting further includes receiving parameter types for the parameter variables via the GUI tool from the user.

10. The method of claim 8 further comprising, receiving a schedule constraint via the GUI tool from the user for executing the rule.

11. The method of claim 8 further comprising, executing the rule as at least one or part of another application and as an independent application represented by the rule.

12. The method of claim 11, wherein executing further includes dynamically acquiring parameter values for the user-defined parameter variables from at least one of command line parameters, a data store table, a file, a prompt made to the user for supplying the parameter values, and an automated service.

13. The method of claim 8 further comprising, supplying one or more drop down menus for selecting parameter types to associate with the parameter variables to the user.

14. A system comprising:
a graphical user interface (GUI) tool; and
an rule generator service, where the GUI tool is to interact with a user to receive SQL parameter variables, parameter types associated with the parameter variables, and SQL statements having references to the parameter variables interspersed therein, and wherein the rule generator service is to generate a rule representing modified SQL statements having the interspersed references.

15. The system of claim 14 further comprising, a scheduling service to receive scheduling constraints for executing the rule or an application have the rule embedded therein.

16. The system of claim 14 further comprising, an execution service to interpret the rule when executed for purposes of dynamically acquiring parameter values for the parameter variables.

17. The system of claim 16, wherein the execution service is invoked automatically when the rule is executed, and wherein the execution service acquires the parameter values from at least one of another service, via interactive prompting of a runtime user, via a data store table lookup, via a file lookup, and via command line parameter values.

18. The system of claim 14, wherein GUI tool is segmented into a plurality of frames, and wherein at least one frame dynamically presents the modified SQL statements as the user constructs the rule in a different one of the frames.

19. The system of claim 14, wherein the rule is at least one of a data store query, a report, and a plan, or wherein the rule is at least a part of another data store query, another report, or another plan.

20. The system of claim 14, wherein the parameter types for the parameter variables are enforced against parameter values supplied at runtime for the rule.
